(19) United States
(12) Patent Application Publication
(10) Pub. No.: US 2023/0185174 A1
(43) Pub. Date: Jun. 15, 2023

(54) MICRO PROJECTION OPTICAL ENGINE

(71) Applicant: IVIEW DISPLAYS (SHENZHEN) COMPANY LTD., Shenzhen (CN)

(72) Inventors: Xiaofeng Tang, Shenzhen (CN); Weizhan Zhu, Shenzhen (CN); Mingnei Ding, Shenzhen (CN); Steve Yeung, Hongkong (CN); Zhiqiang Gao, Hongkong (CN)

(21) Appl. No.: 18/076,704

(22) Filed: Dec. 7, 2022

(30) Foreign Application Priority Data
Dec. 10, 2021 (CN) 202111509313.6

(51) Int. Cl. G03B 21/00; G03B 21/20; H04N 9/31

(52) U.S. Cl. CPC G03B 21/008; G03B 21/2066; H04N 9/317; G02B 3/0056

(57) ABSTRACT

Embodiments of the present disclosure, relating to the field of micro projector engines, provide a micro projection optical engine with a compact layout, small size, and convenient portability. The micro projection optical engine includes a light source and a DMD chip, and a collimating light-combining module, a fly-eye lens, a relay system, a first triangular prism, a compensation lens, a second triangular prism, and a projection lens that are successively disposed in a light exit direction of the light source.

### CROSS-REFERENCE TO RELATED APPLICATION

This application claims the benefit of and priority to the Chinese Patent Application No. 2021115093136, filed to the Chinese patent office on Dec. 10, 2021 and entitled “MICRO PROJECTION OPTICAL ENGINE”, which is hereby incorporated by reference in its entirety.

### TECHNICAL FIELD

Embodiments of the present disclosure relate to the technical field of micro projector engines, and in particular, relate to a micro projection optical engine.

### BACKGROUND

Since a projection image of a projector provides a wide field of view for users, the projector becomes more and more popular among users. With the development of electronic and multimedia technologies, users are imposing higher and higher requirements on projectors, and the projectors develop towards miniaturization and lightweight while the projection effect of the projectors is being continuously optimized, such that the users can easily carry the projector and enjoy a visual effect of large screen anytime and anywhere.

During the practice of embodiments of the present disclosure, the inventors have found that the related art has at least the following problems: Conventional projectors have a large size and are inconvenient for the users to carry, and directions of long and short sides of conventional optical engine are generally inconsistent with directions of long and short sides of a projection region, which limits application scenarios of a projection optical engine when a placement direction of the projection optical engine is required to be consistent with a direction of a target illumination region.

### SUMMARY

The embodiments of the present disclosure provide a micro projection optical engine. The micro projection optical engine includes: a light source, configured to output illumination light, wherein the illumination light is transmitted along a first direction; a collimating light-combining module, disposed in a light exit direction of the light source; a fly-eye lens, disposed in a light exit direction of the collimating light-combining module, wherein the illumination light passes through the collimating light-combining module and the fly-eye lens and is continuously transmitted along the first direction; a relay system, a light incident side of the relay system being disposed in the light exit direction of the fly-eye lens, wherein the relay system is configured to adjust the illumination light from the first direction to a second direction, the first direction being opposite to the second direction; a DMD chip, configured to receive the illumination light and generate image light; a first triangular prism, including a first surface, a second surface, and a third surface, wherein the illumination light is incident into the first triangular prism via the first surface, and is totally reflected via the second surface and is transmitted and exit via the third surface; a compensation lens, disposed proximally to the third surface, and configured to adjust an angle of the illumination light transmitted from the third surface and reflect the illumination light to the second surface for transmissive exit; a second triangular prism, including a fourth surface, a fifth surface, and a sixth surface, wherein the fourth surface and the second surface are integrally fitted, the fifth surface is disposed proximally to the DMD chip, the illumination light is incident into the second triangular prism via the fourth surface and irradiated onto the DMD chip upon exiting via the fifth surface, and the image light generated by the DMD chip is incident into the second triangular prism via the fifth surface and totally reflected via the fourth surface to the sixth surface for transmissive exit; and a projection lens, disposed proximally to the sixth surface, and configured to adjust the image light and cause the image light to exit.

### BRIEF DESCRIPTION OF THE DRAWINGS

One or more embodiments are illustrated by way of example, and not by limitation, in the figures of the accompanying drawings, wherein elements/modules having the same reference numeral designations represent like elements/modules throughout. The drawings are not to scale, unless otherwise disclosed.

FIG. 1 is a schematic structural view of a micro projection optical engine according to an embodiment of the present disclosure;

FIG. 2 is a schematic view illustrating structures and optical paths of a DMD chip, a first triangular prism, a compensation lens, and a second triangular prism in FIG. 1;

FIG. 3 is a schematic structural view of another micro projection optical engine according to an embodiment of the present disclosure; and

FIG. 4 is a schematic view of a projection effect of a micro projection optical engine according to an embodiment of the present disclosure.

Reference numerals and denotations thereof:

10—light source;

20—collimating light-combining module;

30—fly-eye lens;

40—relay system;

41—first reflective mirror;

42—first relay lens;

43—second reflective mirror;

44—second relay lens;

50—DMD chip;

60—first triangular prism;

70—compensation lens;

80—second triangular prism;

90—projection lens;

S1—first surface;

S2—second surface;

S3—third surface;

S4—fourth surface;

S5—fifth surface; and

S6—sixth surface.

### DETAILED DESCRIPTION

The present disclosure is further described with reference to some exemplary embodiments. The embodiments hereinafter facilitate further understanding of the present disclosure for a person skilled in the art, rather than causing any limitation to the present disclosure. It should be noted that persons of ordinary skill in the art may derive various variations and modifications without departing from the inventive concept of the present disclosure. Such variations and modifications shall pertain to the protection scope of the present disclosure.

For clearer descriptions of the objectives, technical solutions, and advantages of the present disclosure, the present disclosure is further described with reference to specific embodiments and attached drawings. It should be understood that the specific embodiments described herein are only intended to explain the present disclosure instead of limiting the present disclosure.

It should be noted that, in the absence of conflict, embodiments of the present disclosure and features in the embodiments may be incorporated, which all fall within the protection scope of the present disclosure. In addition, although function module division is illustrated in the schematic diagrams of devices, and in some occasions, module division different from the divisions of the modules in the devices may be used. Further, the terms “first,” “second,” “third,” “fourth,” “fifth,” and the like used in this text do not limit data and execution sequences, and are intended to distinguish identical items or similar items having substantially the same functions and effects. As used herein, the terms “left,” “right,” and the like expressions are used for illustration purposes only.

Unless the context clearly requires otherwise, throughout the specification and the claims, technical and scientific terms used herein denote the meaning as commonly understood by a person skilled in the art. Additionally, the terms used in the specification of the present disclosure are merely for description the embodiments of the present disclosure, but are not intended to limit the present disclosure. As used herein, the term “and/or” in reference to a list of one or more items covers all of the following interpretations of the term: any of the items in the list, all of the items in the list and any combination of the items in the list.

In addition, technical features involved in various embodiments of the present disclosure described hereinafter may be combined as long as these technical features are not in conflict.

Hereinafter, the embodiments of the present disclosure are illustrated with reference to the accompanying drawings.

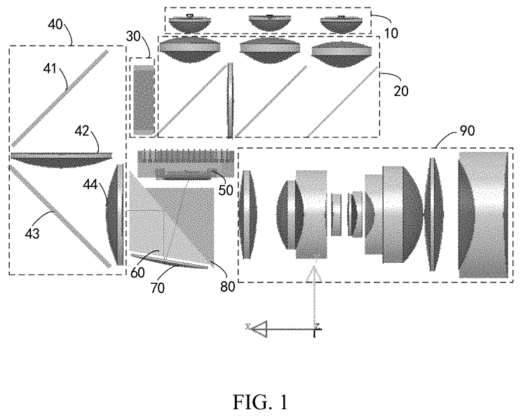

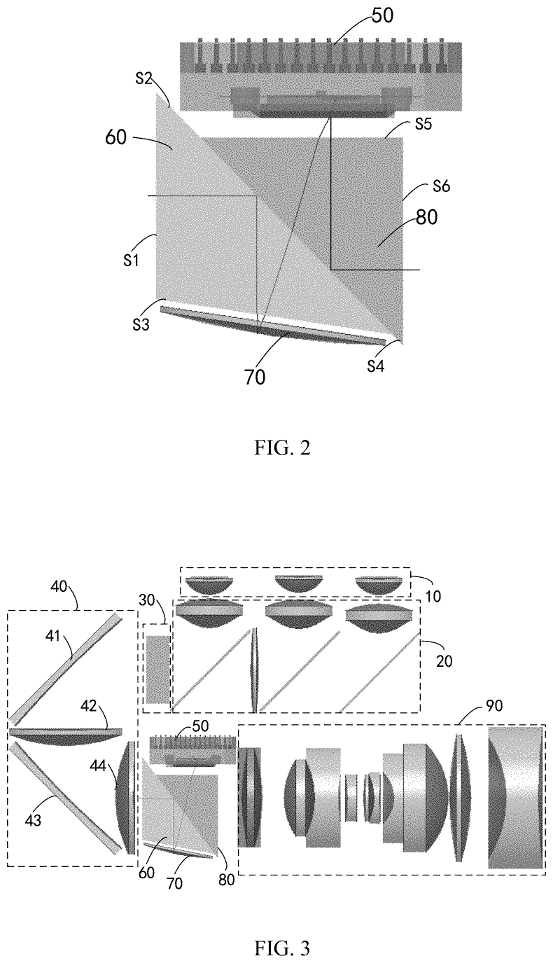

An embodiment of the present disclosure provides a micro projection optical engine. Referring to FIG. 1 and FIG. 2, FIG. 1 illustrates a structure of a micro projection optical engine according to an embodiment of the present disclosure, and FIG. 2 illustrates structures and optical paths of a DMD chip, a first triangular prism, and a second triangular prism in FIG. 1. The micro projection optical engine includes: a light source 10, a collimating light-combining module 20, a fly-eye lens 30, a relay system 40, a DMD chip 50, a first triangular prism 60, a compensation lens 70, a second triangular prism 80, and a projection lens 90.

The light source 10 is configured to output illumination light, wherein the illumination light is transmitted along a first direction. In some embodiments, the light source 10 is a laser light source or a light-emitting diode (LED) light source or the like, which is selected according to actual needs. In an example illustrated in FIG. 1, the first direction is a right-to-left direction, and the second direction is a left-to-right direction.

The collimating light-combining module 20 is disposed in a light exit direction of the light source 10. The collimating light-combining module 20 is configured to collimate light, and combine R light, G light, and B light output from the light source 10 and cause the combined light to exit. In some embodiments, the structure of the collimating light-combining module 20 is designed according to actual needs, which is not limited to the example illustrated in FIG. 1.

The fly-eye lens 30 is disposed in a light exit direction of the collimating light-combining module 20, wherein the illumination light passes through the collimating light-combining module and the fly-eye lens and is continuously transmitted along the first direction. In some embodiments, the fly-eye lens 30 is a fly-eye diffuser lens, and the fly-eye lens 30 diffuses the illumination light and causes the diffused illumination light to exit.

A light incident side of the relay system 40 is disposed in the light exit direction of the fly-eye lens 30, wherein the relay system 40 is configured to adjust the illumination light from the first direction to a second direction, wherein the first direction is opposite to the second direction. In some embodiments, the specific structure of the relay system 40, for example, the set number of lenses, and the model, material and the like of the lenses, is designed according to actual needs, which is not limited to the example in the embodiment illustrated in FIG. 1.

In some embodiments, still referring to FIG. 1, the relay system 40 includes: a first reflective mirror 41, disposed in the light exit direction of the fly-eye lens 30, and configured to carry out a first adjustment on a direction of the illumination light; a first relay lens 42, disposed in the light exit direction of reflected light of the first reflective mirror 41; a second reflective mirror 43, disposed in a light exit direction of the first relay lens 42, and configured to carry out a second adjustment on the direction of the illumination light and output illumination light transmitted along the second direction; and a second relay lens 44, disposed between the second reflective mirror 43 and the first triangular prism 60. An included angle defined between the first reflective mirror 41 and the first relay lens 42 is 45°±20°, and an included angle defined between the first relay lens 42 and the second reflective mirror 43 is 45°±20°. A ratio of the distance from the fly-eye lens 30 to the first relay lens 42 to the distance from the first relay lens 42 to the second relay lens 44 is T, 0.5≤T≤2, and a ratio of a focal length f1 of the first relay lens 42 to a focal length f2 of the second relay lens 44 satisfies: 0.5≤f1/f2 ≤2.

As illustrated in FIG. 1, the first reflective mirror 41 and the second reflective mirror 43 are planar mirrors. In some embodiments, referring to FIG. 3, FIG. 3 illustrates a structure of another micro projection optical engine according to an embodiment of the present disclosure. As illustrated in FIG. 3, the first reflective mirror 41 and the second reflective mirror 43 are non-planar mirrors. In some embodiments, structural configurations defining whether the first reflective mirror 41 and/or the second reflective mirror 43 is a planar mirror and the curvature in the case that the first reflective mirror 41 and/or the second reflective mirror 43 is a non-planar mirror is designed according to actual needs, which are not limited to those in the embodiments of the present disclosure.

The DMD chip 50 is configured to receive the illumination light and generate image light. The digital micromirror device (DMD) chip 50 is a core of digital light processing (DLP), which is capable of receiving the illumination light and adjusting a switching frequency to generate the image light for projection imaging.

The first triangular prism 60 includes a first surface S1, a second surface S2, and a third surface S3, wherein the illumination light is incident into the first triangular prism 60 via the first surface S1, and is totally reflected via the second surface S2 and is transmitted and exit via the third surface S3. In some embodiments, an included angle α defined between the first surface S1 and the second surface S2 of the first triangular prism 60 is 45°±20°. In some embodiments, the first surface S1 and the third surface S3 are each coated with a highly-transparent film, the second surface S2 is coated with a semi-reflective and semi-transparent film, and, in some embodiments the film is a metal film or a dielectric film.

The compensation lens 70 is disposed proximally to the third surface S3, and configured to adjust an angle of the illumination light transmitted exiting from the third surface S3 and reflect the illumination light to the second surface S2 for transmissive exit. The compensation lens 70 is capable of adjusting the angle of the illumination light, such that the illumination light reaches the second surface S2 with an incident angle less than a total reflection angle, thereby causing the light to be transmitted and exit.

The second triangular prism 80 includes a fourth surface S4, a fifth surface S5, and a sixth surface S6, wherein the fourth surface S4 and the second surface S2 are integrally fitted, the fifth surface S5 is disposed proximally to the DMD chip 50, the illumination light is incident into the second triangular prism 80 via the fourth surface S4 and irradiated onto the DMD chip 50 upon exiting via the fifth surface S5, and the image light generated by the DMD chip 50 is incident into the second triangular prism 80 via the fifth surface S5 and totally reflected via the fourth surface S4 to the sixth surface S6 for transmissive exit. In some embodiments, the fourth surface S4 is coated with a semi-reflective and semi-transparent film, the fifth surface S5 and the sixth surface S6 are each coated with a highly-transparent film, and, in some embodiments the film is a metal film or a dielectric film. In some embodiments, the second triangular prism 80 is an isosceles right-angled prism.

The projection lens 90 is disposed proximally to the sixth surface S6, and configured to adjust the image light and cause the image light to exit. In some embodiments, the projection lens 90 is configured to adjust the light to a suitable size, and/or to address possible distortion problems of the image light, and/or to adjust a focal length and the like of the image. In some embodiments, the specific structure of the projection lens 90, for example, the set number of lenses, and the model, material and the like of the lenses, is designed according to actual functional needs on the projection lens 90, which is not limited to the example in the embodiments illustrated in FIG. 1 and FIG. 3.

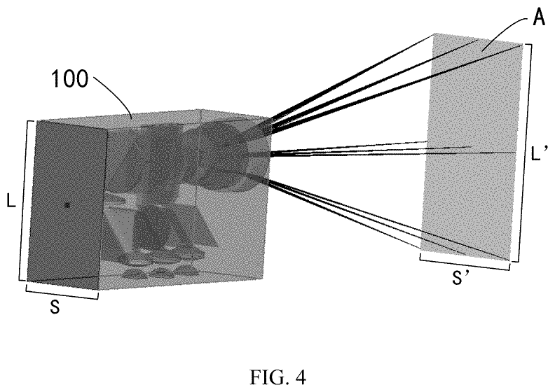

Referring to FIG. 4, FIG. 4 illustrates a projection effect of a micro projection optical engine 100 according to some embodiments of the present disclosure. As illustrated in FIG. 4, some embodiments of the present disclosure provide a DLP micro projection optical engine with a compact layout, small size, and convenient portability. In addition, when a placement direction of the projection optical engine is required to be consistent with a direction of a target illumination region A, a long side L of the micro projection optical engine according to the embodiments of the present disclosure corresponds to a field side L′ of the target illumination region, and likewise, a short side S of the micro projection optical engine corresponds to a short side S′ of the illumination region.

In summary, the embodiments of the present disclosure provide a micro projection optical engine with a compact layout, small size, and convenient portability. The micro projection optical engine includes a light source and a DMD chip, and a collimating light-combining module, a fly-eye lens, a relay system, a first triangular prism, a compensation lens, a second triangular prism, and a projection lens that are successively disposed in a light exit direction of the light source. According to the present disclosure, an optical path direction of the illumination light is adjusted by the relay system and an optical path direction of the image light is adjusted by an optical path design of the DMD chip, the first triangular prism, the compensation lens and the second triangular prism, such that directions of long and short sides of a projection region are maintained consistent with directions of long and short sides of the projection optical engine in the case that the exited image light is projected and imaged.

It should be noted that the above described device embodiments are merely for illustration purpose only. The units which are described as separate components may be physically separated or may be not physically separated, and the components which are illustrated as units may be or may not be physical units, that is, the components may be deployed in the same position or may be distributed into a plurality of network units. Part or all of the modules may be selected according to the actual needs to achieve the objects of the technical solutions of the embodiments.

Finally, it should be noted that the above embodiments are merely used to illustrate the technical solutions of the present disclosure rather than limiting the technical solutions of the present disclosure. Under the concept of the present disclosure, the technical features of the above embodiments or other different embodiments may be combined, the steps therein may be performed in any sequence, and various variations may be derived in different aspects of the present disclosure, which are not detailed herein for brevity of description. Although the present disclosure is described in detail with reference to the above embodiments, persons of ordinary skill in the art should understand that they may still make modifications to the technical solutions described in the above embodiments, or make equivalent replacements to some of the technical features; however, such modifications or replacements do not cause the essence of the corresponding technical solutions to depart from the spirit and scope of the technical solutions of the embodiments of the present disclosure.

What is claimed is:

1. A micro projection optical engine, comprising:
a light source, configured to output illumination light, wherein the illumination light is transmitted along a first direction;
a collimating light-combining module, disposed in a light exit direction of the light source;
a fly-eye lens, disposed in a light exit direction of the collimating light-combining module, wherein the illumination light passes through the collimating light-combining module and the fly-eye lens and is continuously transmitted along the first direction;
a relay system, a light incident side of the relay system being disposed in the light exit direction of the fly-eye lens, wherein the relay system is configured to adjust the illumination light from the first direction to a second direction, the first direction being opposite to the second direction;
a DMD chip, configured to receive the illumination light and generate image light;
a first triangular prism, comprising a first surface, a second surface, and a third surface, wherein the illumination light is incident into the first triangular prism via the first surface, and is totally reflected via the second surface and is transmitted and exit via the third surface;
a compensation lens, disposed proximally to the third surface, and configured to adjust an angle of the illumination light transmitted from the third surface and reflect the illumination light to the second surface for transmissive exit;
a second triangular prism, comprising a fourth surface, a fifth surface, and a sixth surface, wherein the fourth surface and the second surface are integrally fitted, the fifth surface is disposed proximally to the DMD chip, the illumination light is incident into the second triangular prism via the fourth surface and irradiated onto the DMD chip upon exiting via the fifth surface, and the image light generated by the DMD chip is incident into the second triangular prism via the fifth surface and totally reflected via the fourth surface to the sixth surface for transmissive exit; and
a projection lens, disposed proximally to the sixth surface, and configured to adjust the image light and cause the image light to exit.

2. The micro projection optical engine according to claim 1, wherein
the first surface, the third surface, the fifth surface, and the sixth surface are each coated with a highly-transparent film.

3. The micro projection optical engine according to claim 1, wherein
the second surface and the fourth surface are each coated with a semi-reflective and semi-transparent film.

4. The micro projection optical engine according to claim 1, wherein the relay system comprises:
a first reflective mirror, disposed in the light exit direction of the fly-eye lens, and configured to carry out a first adjustment on a direction of the illumination light;
a first relay lens, disposed in the light exit direction of reflected light of the first reflective mirror;
a second reflective mirror, disposed in a light exit direction of the first relay lens, and configured to carry out a second adjustment on the direction of the illumination light and output illumination light transmitted along the second direction; and
a second relay lens, disposed between the second reflective mirror and the first triangular prism.

5. The micro projection optical engine according to claim 4, wherein
an included angle defined between the first reflective mirror and the first relay lens is 45°±20°.

6. The micro projection optical engine according to claim 4, wherein
an included angle defined between the first relay lens and the second reflective mirror is 45°±20°.

7. The micro projection optical engine according to claim 4, wherein
a ratio of a distance from the fly-eye lens to the first relay lens to a distance from the first relay lens to the second relay lens is T, wherein 0.5≤T≤2.

8. The micro projection optical engine according to claim 4, wherein
a ratio of a focal length f1 of the first relay lens to a focal length f2 of the second relay lens satisfies: 0.5≤f1/f2≤2.

9. The micro projection optical engine according to claim 4, wherein
the first reflective mirror and/or the second reflective mirror is a non-planar mirror.

10. The micro projection optical engine according to claim 4, wherein
the first reflective mirror and/or the second reflective mirror is a planar mirror.

11. The micro projection optical engine according to claim 1, wherein
the second triangular prism is an isosceles right-angled prism.

12. The micro projection optical engine according to claim 1, wherein
an included angle α defined between the first surface and the second surface of the first triangular prism is 45°±20°.
